(19) United States
(12) Patent Application Publication
(10) Pub. No.: US 2009/0049445 A1
(43) Pub. Date: Feb. 19, 2009

(54) METHOD, SYSTEM AND APPARATUS FOR TASK PROCESSING IN DEVICE MANAGEMENT

(75) Inventors: Qi SHU, Shenzhen (CN); Xiaoqian CHAI, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/251,908

(22) Filed: Oct. 15, 2008

Related U.S. Application Data
(63) Continuation of application No. PCT/CN2007/000921, filed on Mar. 21, 2007.

(30) Foreign Application Priority Data
Apr. 17, 2006 (CN) 200610066651.6
Jun. 20, 2006 (CN) 200610086759.1

(51) Int. Cl. G06F 9/46

(52) U.S. Cl. 718/102

(57) ABSTRACT

The disclosure provides a method, system and apparatus for task processing in device management so that a scheduled task may be triggered and executed normally, according to a predetermined triggering condition when the execution of the task is affected by a state of a terminal device or an operation of the terminal device. The method according to the invention includes steps of determining a scheduled task when the execution of the scheduled task is affected by a state of a terminal device or an operation of the terminal device; and prompting a user to select a processing manner for the scheduled task, and processing the affected scheduled task according to the user's selection, or processing the scheduled task in a predetermined processing manner.

### CROSS-REFERENCE TO RELATED APPLICATION

This application is a continuation of International Patent Application No. PCT/CN2007/000921, filed Mar. 21, 2007, which claims priority to Chinese Patent Application No. 200610066651.6, filed Apr. 17, 2006, and Chinese Patent Application No. 200610086759.1, filed Jun. 20, 2006, all of which are hereby incorporated by reference in their entirety.

### FIELD OF THE INVENTION

The invention relates to communication field, and more particularly, to a method, and apparatus for task processing in device management.

### BACKGROUND

Presently, as the functionality of a terminal device becomes more and more complicated, the terminal software is increasingly prone to various failures. The terminal device may include, but not limited to, for example, a mobile terminal, a palm computer, a notebook computer, an embedded device, or an on-board system. To effectively guarantee good user experience and Quality of Service (QoS), as well as reduce the maintenance cost for the terminal device, the Open Mobile Alliance (OMA) develops the OMA Device Management (DM) V1.2 specification. The OMA DM V1.2 specification is a unified standard designed to define the overall architecture, the protocol, the communication mechanism, the security, and the like for device management.

In the specification, in addition to the synchronous device management mode (in which a management operation is completed during one session) and the asynchronous device management mode (in which a DM management operation is completed during several sessions), a task scheduling mode is also provided. A Device Management Server (DMS) may schedule a task and its triggering condition, and send them to the terminal device so that the terminal device can automatically perform the DMS management operation according to the predetermined time or condition, even when the terminal device is offline. The purpose of this mode is to reduce the overhead of network resources, enhance the DM flexibility, and improve the user experience in the device management process. The flow chart for the task scheduling mode is shown in FIG. 1, and the following steps are involved:

1. A server sends a notification to a terminal.

2. The terminal establishes a session connection with the server.

3. The server sends a management task.

4. The terminal prompts a user for information about the management task.

5. The user accepts the management task.

6. The terminal reports the state of the task.

7. The server closes the session.

8. In a state that the execution of the management task is not affected, the terminal device monitors the condition of the management task. For example, the state in which the execution of the management task is not affected may be the STANDBY state.

9. The terminal device executes the management task in a state that the execution of the management operation task is not affected.

10. The terminal establishes a connection with the server initiatively and reports the state of the execution of the management task.

11. The server closes the session (the server may continue to send management command).

It may be seen from the above flow that the terminal device can monitor the management task only in a state that the execution of the management operation task is not affected. However, various exceptions may occur to the terminal device at any time (for example, the terminal is automatically turned off due to the battery exhausts, or the terminal is automatically turned off at the timing set by the user, or the terminal is automatically turned off due to some errors of the terminal, or the terminal is turned off due to some behaviors from the user). The occurrence of these exceptions will cause the management task unable to be triggered and executed normally according to the preset triggering conditions.

### SUMMARY

Embodiments of the invention provide a method, system and apparatus for task processing in device management so that a scheduled task may be triggered and executed normally according to the predetermined triggering condition when the execution of the task is affected by the current state of a terminal device or an operation of the terminal device.

An embodiment of the invention provides a method including steps of determining a scheduled task when the execution of the scheduled task is affected by a state of a terminal device or an operation of the terminal device; and prompting a user to select a processing manner for the scheduled task, and processing the affected scheduled task according to the user's selection, or processing the scheduled task in a predetermined processing manner.

An embodiment of the invention provides a terminal device management system (500, 600), including: a device management server (502, 602) configured to send a task and receive an execution result, and a terminal device (504, 604) configured to interact with the device management server (502, 602). The terminal device (504, 604) further includes a device management task exception processing module (5046, 6046), configured to determine a scheduled task when the execution of the scheduled task is affected by a state of the terminal device or an operation of the terminal device, and prompt a user to select a processing manner for the scheduled task and process the affected scheduled task, according to the user's selection, or process the scheduled task in a predetermined processing manner.

An embodiment of the invention provides a terminal device (504, 604), including: a device management task processing module (5042, 6042), configured to process a scheduled task sent from a device management server (502, 602) and return an execution result; a device management client module (5044, 6044) interacting directly with the device management server (502, 602), configured to forward signaling exchanged between the device management server (502, 602) and the terminal device (504, 604); and a device management task exception processing module (5046, 6046), configured to determine a scheduled task when the execution of the scheduled task is affected by a state of the terminal device (504, 604) or an operation of the terminal device (504, 604), and prompt a user to select a processing manner for the scheduled task and process the affected scheduled task, according to the user's selection, or process the scheduled task in a predetermined processing manner.

According to the embodiments of the invention, a determination condition is set on the terminal device. If the user activates a function of determining whether an exception occurs in the determination condition, monitoring of the exception may be activated. With the embodiments of the invention, the task may be monitored even there is an exception, and may be executed automatically or executed, according to the user's selection.

### BRIEF DESCRIPTION OF THE DRAWINGS

FIG. 1 is a flow chart showing the task scheduling mode;

FIG. 2 is a task processing flow chart of a terminal device when transiting from an ON state to an OFF state with a method, according to an embodiment of the present invention;

FIG. 3 is a task processing flow chart of a terminal device when transiting from an OFF state to an ON state with a method, according to an embodiment of the present invention;

FIG. 4 is a task processing flow chart of a terminal device in an OFF state executing a task with a method, according to an embodiment of the present invention;

FIG. 5 is a schematic diagram showing the configuration of a first system, according to an embodiment of the present invention; and

FIG. 6 is a schematic diagram showing the configuration of a second system, according to an embodiment of the present invention.

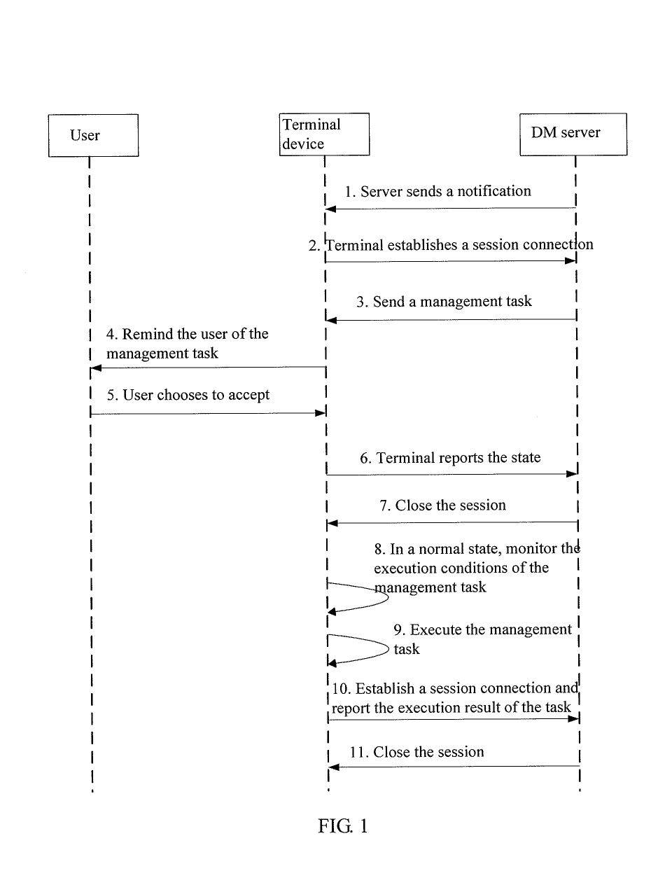

### DETAILED DESCRIPTION

A method is provided in an embodiment of the invention to trigger and execute the scheduled task normally according to the preset triggering condition even in an exception (when the execution of the scheduled task is affected by the current state of the terminal device or an operation of the terminal device).

For a user, if the user fails to perform a necessary operation on the terminal device, the current state of the terminal device is likely to affect the execution of the scheduled task; if the user performs a relevant operation on the terminal device, the operation of the terminal device is likely to affect the execution of the scheduled task. The operation of the terminal device affecting the execution of the scheduled task may further be classified into the following cases: the terminal device attempts to transit to the OFF state from the ON state; the terminal device transits to the ON state from the OFF state; and while in the ON state, the terminal device adjusts the system time of the terminal device.

When the terminal device manages a task, the execution of the task is limited by the deadline of the execution and the necessity of the execution. Due to the above two limitations, tasks may be classified into four types:

Type 1: tasks optional to be executed and not exceeding the deadline;

Type 2: tasks mandatory to be executed and not exceeding the deadline;

Type 3: tasks optional to be executed and exceeding the deadline; and

Type 4: tasks mandatory to be executed and exceeding the deadline.

An operation of the terminal device may affect the execution of the scheduled task in the following aspects.

### EXAMPLE 1

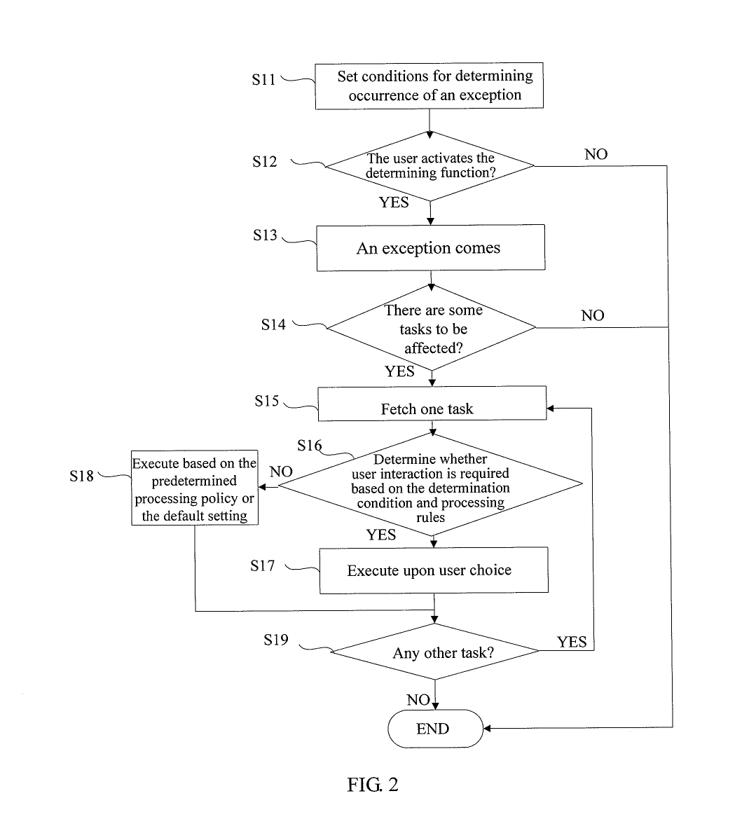

A terminal device attempts to transit from an ON state to an OFF state, which affects the execution of the task. The flow of this example is shown in FIG. 2, and the following steps are involved.

S11: Determination conditions are set in the terminal device. The determination conditions include the following:

(1) The determination condition for the occurrence of an exception. For example, the battery power of the terminal device is less than 5% or a pre-defined power-off time is reached, or the user is pressing the OFF key.

(2) The determination condition for the affected task. For example, a time period of 8 hours is set. The time when an exception occurs is taken as the starting time, and any tasks scheduled to be triggered within the 8 hours are determined as the tasks to be affected.

(3) The processing rules. The processing rules include: processing a task based on the predetermined processing policy (the processing policy sent from the server and/or pre-set by the user), processing a task based on the user's choice or in a default manner. The processing policy sent from the server at least includes: one of immediate execution, delayed execution, and discard of execution, and reporting to the server. For example, for a Type 1 task, the user may choose to execute the task immediately, or delay the execution of the task to a certain time point, or discard the execution. For a Type 2 task, discard of execution is not allowed. For a Type 3 task, the user may choose immediate execution or discard of execution. For a Type 4 task, the user is not allowed to make any choice, and the terminal device will execute the task immediately based on the default setting.

The user may also preset a processing policy for tasks of Type 1, 2, or 3. Accordingly, when a Type 1, 2, or 3 task should be executed, the user will not be prompted to make a choice again; instead, the task will be executed directly based on the preset processing policy.

S12: After the above determination condition is set, the user may choose to activate or not activate the set determination condition. If the user chooses not to activate the determination condition, the subsequent operations are the same as those in the prior art so that the user is not reminded by the terminal device when an exception occurs. If the user chooses to activate the determination condition, the exception is monitored.

S13: There is an exception, for example, at 18:00, the battery power of the terminal device is less than 5%.

S14: Based on the set determination condition, the time of 18:00 is used as the starting time to find whether any scheduled task should be triggered in the following 8 hours. If there is such a task, the task is determined as the affected task. Obviously, the tasks may be one or more than one. If there is no such a task, no operation is performed.

S15: A task is fetched from the tasks.

S16: It is determined whether an interaction from the user is required based on the set determination condition and the processing rules.

S17: If the user's interaction is required (that is, requiring the user to grant), the user is prompted to select a processing way for the task. For example, if the currently fetched task belongs to Type 1, the user may choose the task either to be executed immediately, or not to be executed, or to be delayed and executed at a certain time point.

S18: If an interaction from the user is not required, the terminal device directly processes the task based on the predetermined processing policy or the default setting. For example, the task may be executed directly.

S19: After the scheduled task is processed upon the user's choice, or is processed by the terminal device based on the predetermined processing policy or the default setting, it is determined whether there is any other task to be affected. If there is any task to be affected, jump to step S15, and continue the above processing flow. If there is no task to be affected, it indicates that all the affected tasks have been processed, and the terminal device continues the subsequent power-off operation.

### EXAMPLE 2

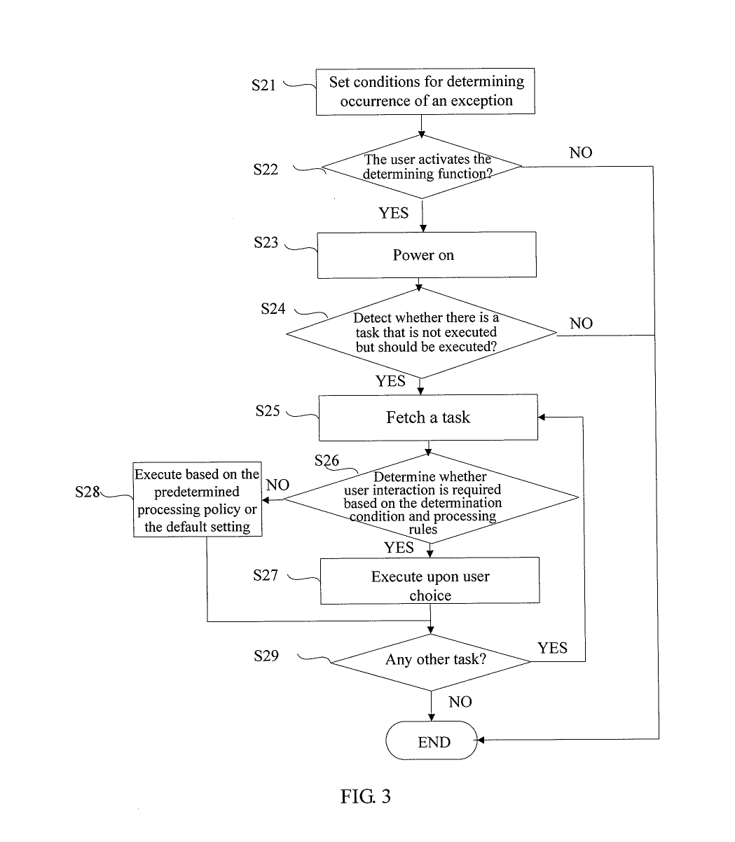

A terminal device attempts to transit from an OFF state to an ON state. The flow of this example is shown in FIG. 3, and the following steps are involved.

S21: Determination conditions are set on the terminal device, and the determination conditions include the following.

(1) The condition for starting detection. For example, detection is made every time the terminal device is turned on.

(2) The determining condition for the affected task. For example, a task is identified, which should be processed but has not been processed during the last duration of powering off the terminal device.

(3) The processing rules. The processing rules include: processing a task based on the predetermined processing policy (the processing policy sent from the server and/or pre-set by the user), processing a task based on the user's choice or in a default manner. The processing policy sent from the server at least includes: one of immediate execution, delayed execution, and discard of execution, and reporting to the server. For example, for a Type 1 task, the user may choose to execute the task immediately, or delay the execution of the task to a certain time point, or discard the execution. For a Type 2 task, discard of execution is not allowed. For a Type 3 task, the user may choose immediate execution or discard of execution. For a Type 4 task, the user is not allowed to make any choice, and the terminal device will execute the task immediately based on the default setting.

The user may also preset a processing policy for tasks of Type 1, 2, or 3. Accordingly, when a Type 1, 2, or 3 task should be executed, the user will not be prompted to make a choice again; instead, the task will be executed directly based on the preset processing policy.

S22: After the above determination condition is set, the user may choose to activate or not activate the set determination condition. If the user chooses not to activate the determination condition, the subsequent operations are the same as those in the prior art so that the user is not reminded by the terminal device when an exception occurs. If the user chooses to activate the determination condition, the exception is monitored.

S23: The user turns on the terminal device, for example, the terminal device was turned off at 20:00, and then it is turned on at 22:00 now.

S24: A check is made as to whether there is any task that should be processed but has not been processed yet during the time period from 20:00 to 22:00. Obviously, there may be more than one task that should be processed but has not been processed yet during the time period.

S25: A task is fetched from the tasks.

S26: It is determined whether an interaction from the user is required, based on the set determination condition and the processing rules.

S27: If the user's interaction is required, the user is prompted to select a processing way for the task. For example, if the currently fetched task belongs to Type 1, the user may choose the task either to be executed immediately, or not to be executed, or to be delayed and executed at a certain time point. Alternatively, if the currently extracted task belongs to Type 3, the user may choose the task either to be executed immediately, or not to be executed.

S28: If an interaction from the user is not required, the terminal device directly processes the task based on the predetermined processing policy or the default setting. For example, the task may be executed directly.

S29: After the task is processed upon the user's choice, or is processed by the terminal device based on the predetermined processing policy or the default setting, it is determined whether there is any other task to be executed. If there is any other task to be executed, jump to Step S25, and continue the above processing flow. If there is no task to be executed, it indicates that all the affected tasks have been processed.

### EXAMPLE 3

The terminal device time is adjusted so that the execution of the task is affected.

S31: Determination conditions are set on the terminal device, and the determination conditions include the following.

(1) The condition for starting detection. For example, detection is made every time the adjustment of the terminal device time.

(2) The condition for determining the affected task. For example, a task is identified, which should be processed, but has not been processed during the skipped time period caused by the adjustment of the system time.

(3) The processing rules. The processing rules include: processing a task based on the predetermined processing policy (the processing policy sent from the server and/or pre-set by the user), processing a task based on the user's choice or in a default manner. The processing policy sent from the server at least includes: one of immediate execution, delayed execution, and discard of execution, and reporting to the server. For example, for a Type 1 task, the user may choose to execute the task immediately, or delay the execution of the task to a certain time point, or discard the execution. For a Type 2 task, discard of execution is not allowed. For a Type 3 task, the user may choose immediate execution or discard of execution. For a Type 4 task, the user is not allowed to make any choice, and the terminal device will execute the task immediately.

The user may also preset a processing policy for tasks of Type 1, 2, or 3. Accordingly, when a Type 1, 2, or 3 task should be executed, the user will not be prompted to make a choice again; instead, the task will be executed directly based on the preset processing policy.

S32: After the above determination condition is set, the user may choose to activate or not activate the set determination condition. If the user chooses not to activate the determination condition, the subsequent operations are the same as those in the prior art so that the user is not reminded by the terminal device when an exception occurs. If the user chooses to activate the determination condition, the exception is monitored.

S33: The terminal device time is adjusted. For example, the system time is adjusted from 20:00 to 22:00.

S34: A check is made as to whether there is any task that should be processed but has not been processed yet during the time period from 20:00 to 22:00. Obviously, there may be more than one task that should be processed but has not been processed yet during the time period.

S35: A task is fetched from the tasks.

S36: It is determined whether an interaction from the user is required based on the set determination condition and the processing rules.

S37: If the user's interaction is required (that is, requiring the user to grant), the terminal device prompts the user to select a processing way for the task. For example, if the currently extracted task belongs to Type 1, the user may choose the task either to be executed immediately, or not to be executed, or to be delayed and executed at a later time point. Alternatively, if the currently extracted task belongs to Type 3, the user may choose the task either to be executed immediately, or not to be executed.

S38: If an interaction from the user is not required, the terminal device directly processes the task based on the predetermined processing policy or the default setting. For example, the task may be executed directly.

S39: After the task is processed upon the user's choice, or is processed by the terminal device based on the predetermined processing policy or the default setting, it is determined whether there is any other task to be executed. If there is any other task to be executed, jump to Step S35, and continue the above processing flow. If there is no task to be executed, it indicates that all the affected tasks have been processed.

### EXAMPLE 4

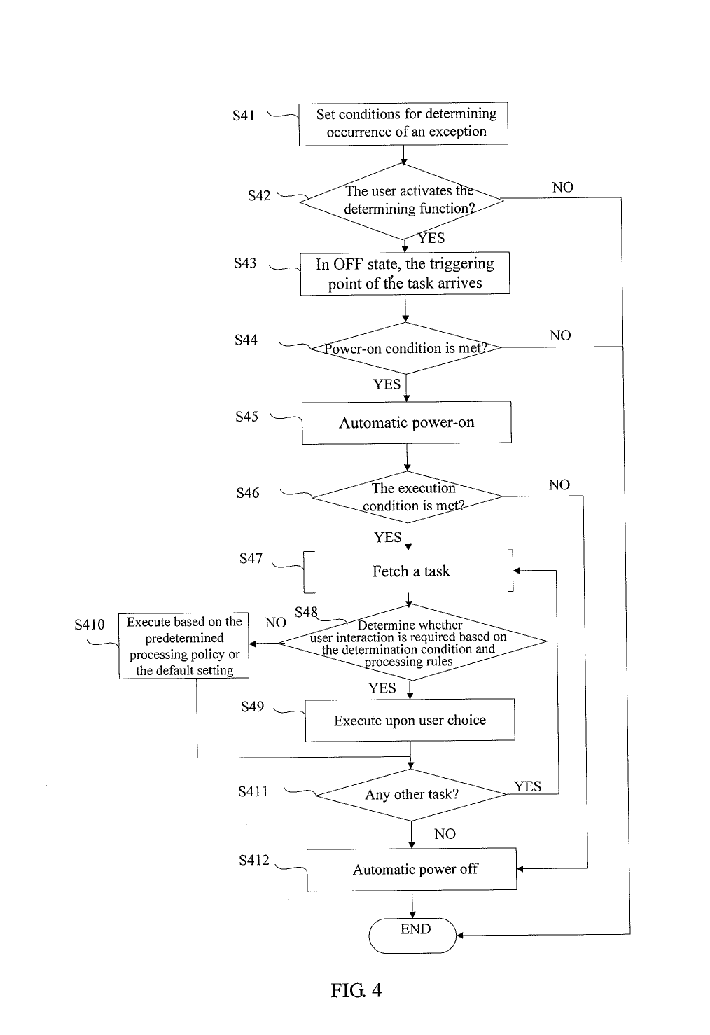

The current state of the terminal device affects the execution of the scheduled task. The flow of this example is shown in FIG. 4, and the following steps are involved.

S41: Determination conditions are set on the terminal device, and the determination conditions include the following.

(1) The condition for determining whether an exception occurs. That is, when the triggering point for a task arrives, the terminal device is in the OFF state.

(2) The condition for determination of an affected task. That is, a task to be executed when the terminal device is in the OFF state.

(3) The condition for whether automatic power-on is allowed. For example, only when the terminal device is in the airplane mode, automatic power-on is not allowed.

(4) The condition for determining whether a task may be executed. For example, only when the current power is more than 5%, the task may be executed; or set a threshold for the signal strength.

(5) The processing rules. The processing rules include: processing a task based on the predetermined processing policy (the processing policy sent from the server and/or pre-set by the user), and processing a task based on the user's choice or in a default manner. The processing policy sent from the server at least includes: one of immediate execution, delayed execution, and discard of execution, and reporting to the server. For example, for a Type 1 task, the user may choose to execute the task immediately, or delay the execution of the task to a certain time point, or discard the execution. For a Type 2 task, discard of execution is not allowed. For a Type 3 task, the user may choose immediate execution or discard of execution. For a Type 4 task, the user is not allowed to make any choice, and the terminal device will execute the task immediately.

The user may also preset a processing policy for tasks of Type 1, 2, or 3. Accordingly, when a Type 1, 2, or 3 task should be executed, the user will not be prompted to make a choice again; instead, the task will be executed directly based on the preset processing policy.

S42: After the above determination condition is set, a user may choose to activate or not activate the set determination condition. If the user chooses not to activate the determination condition, the subsequent operations are the same as in the prior art so that the user is not reminded by the terminal device when an exception occurs. If the user chooses to activate the determination condition, the exception is monitored.

S43: When an exception occurs, for example, the user schedules a task to return the current position information of the terminal device to the DMS at 19:00, but the terminal device is in the OFF state at 19:00. Apparently, there may be more than one task to be executed at 19:00.

S44: The terminal device determines whether the power-on condition is satisfied currently.

S45: If the user has not activated the airplane mode, it is determined that automatic power-on is allowed. Afterwards, the terminal device is powered on automatically if the power permits.

S46: After power-on, the terminal device determines whether the condition of executing the task is satisfied currently.

S47: If the power permits, and the signal meets the requirements for executing the task, fetch a task from the tasks.

S48: It is determined whether an interaction from the user is required, based on the set determination condition and the processing rules.

S49: If the user's interaction is required (that is, requiring the user to grant), the terminal device prompts the user to select a processing way for the task. For example, if the extracted task belongs to Type 1, the user may choose the task either to be executed immediately, or not to be executed, or to be delayed and executed at a later time point.

S410, if an interaction from the user is not required, the terminal device directly processes the task based on the predetermined processing policy or the default setting. For example, the position information of the terminal device is directly returned to DMS.

S411: After the task is processed upon the user's choice, or is processed by the terminal device based on the predetermined processing policy or the default setting, it is determined whether there is any other task to be executed. If there is any other task to be executed, jump to Step S47, and continue the above processing flow. If there is no task to be executed, it indicates that all the affected tasks have been processed and the flow goes to step S412.

S412: The terminal device is powered off automatically.

Based on the overall architecture, the protocol, and the communication mechanism of the DM system, as well as the security and the like in device management defined by OMA DM. An embodiment of the invention also provides a terminal device management system, which is configured to send a scheduled task by using the above DM protocol to terminal device for management of the terminal device.

Four task processing flows are described above under the influence of exceptions. In the OMA DM specification, the DM server performs device control and management by managing an MO (Manager Object). In the process of sending the management task of the terminal device, a management object tree is set for the scheduled task firstly. A basic description of the scheduled task management object in OMA DM is listed below.

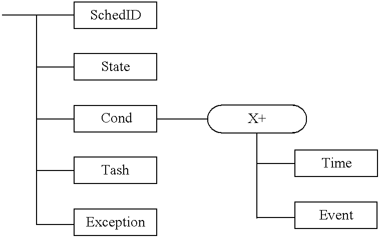

The node SchedID specifies identification the scheduled task. State specifies the state of the scheduled task. Cond is the condition for executing the scheduled task, including the time rule Timer node and the Event node Event node. The Task node records the execution content of the task. In addition, to meet the exception processing policy according to an embodiment of the invention, the Exception node is to be set. The Exception node describes the processing policy when the scheduled task is affected. The node may take values as follows.

| Value | Meaning |
|---|---|
| Execute | The scheduled task is executed normally. When several |
| | exception conditions are satisfied, only the last item is executed. |
| Discard | Cancel the exceptional scheduled task. |
| Inform | Inform the DM server so that the DM server controls the |
| | execution of the task. |

According to an embodiment of the invention, the terminal device management system includes a terminal device (that is, a terminal device, according to the present invention), and a device management server coupled with each other. Communication between the device management server and the terminal device is performed via the DM protocol.

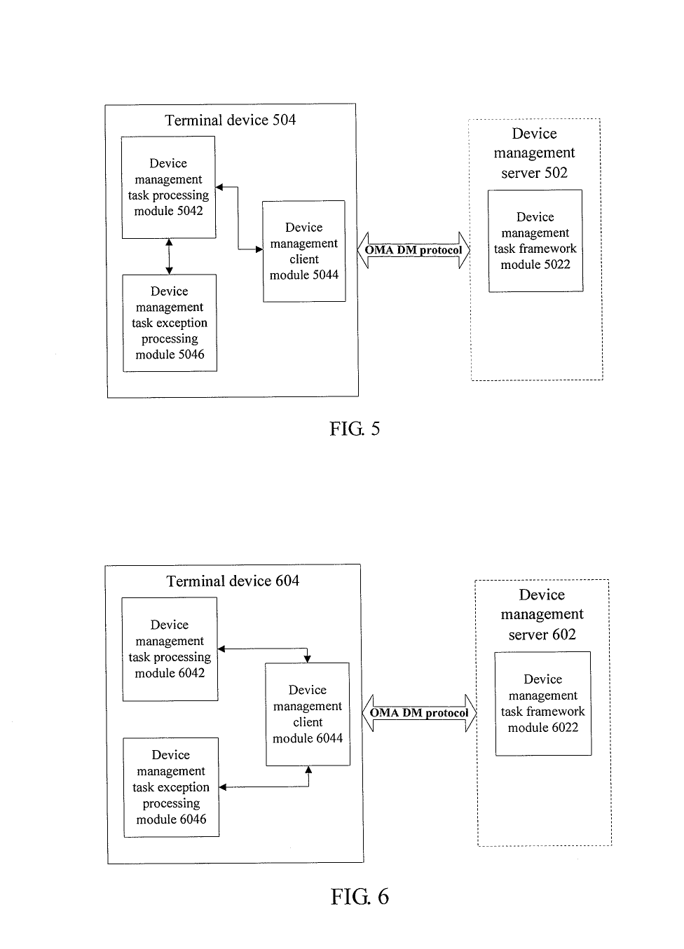

As shown in FIG. 5, the terminal device 504 (that is, a terminal device, according to an embodiment of the present invention) may further include a device management client module 5044, a device management task processing module 5042, and a device management task exception processing module 5046 connected in cascade. The device management server 502 may further include a device management task framework module 5022, which communicates with the device management client module 5044 via the DM protocol.

Alternatively, as shown in FIG. 6, the terminal device 604 (that is, a terminal device, according to the present invention) may further include a device management task processing module 6042 and a device management task exception processing module 6046 connected with the device management client module 6044, respectively. The device management server 602 may further include a device management task framework module 6022, which communicates with the device management client module 6044 via the DM protocol.

The device management task framework module 6022 is configured to send a task to the terminal device 604, and process the interaction result and the execution result returned from the terminal device 604.

The device management task processing module 6042 is configured to process a scheduled task sent from a device management server 602 with the DM protocol forwarded by the device management client module 6044 and return an execution result via the device management client module 6044. The scheduled task may include: installing/setting a task; monitoring the conditions of a task; and controlling and triggering a task. The device management task processing module 6042 is further configured to forward the interaction result sent from the device management exception processing module 6046.

The device management task exception processing module 6046 is configured to monitor an exception in executing the task based on the conditions for executing the scheduled task set by the terminal device 604 (including time, event or the like). Alternatively, the processing policy for exception processing may be set in the device management task exception processing module 6046 (for example, after the task missed the triggering condition, the task is discarded and reported to the DM server).

When an exception occurs, the device management task exception processing module 6046 processes according to the preset processing policy or the system default processing policy, and then returns the processing result to the device management task processing module 6042.

The device management task exception processing module 6046 has an interface with the device management task processing module 6042 for returning the processing result to the device management server 602 via the device management task processing module 6042 and device management client module 6044. Or, the device management task exception processing module 6046 has an interface with the device management client module 6044 for returning the processing result to the device management server 602 directly via the device management client module 6044.

The device management client module 6044 interacts directly with the device management server 602, and is configured to forward signaling exchanged between the device management server 602 and the terminal device 604. In other words, the device management client module 6044 is configured to forward a scheduled task sent from the device management server 602 to the device management task processing module 6042, and forward the task execution result of the device management task processing module 6042 to the device management server 602, as well as forward the interaction result of the device management task exception processing module 6046 to the device management server 602.

As described above, by setting a determination condition on the terminal device according to an embodiment of the invention, exception monitoring is enabled if the user activates a function of determining the occurrence of an exception in the determination condition.

Before an exception is likely to occur, i.e. the terminal device attempts to transit to the OFF state from the ON state, the terminal device takes the current time as the starting time, determines a scheduled task to be affected within a preset time period, and pre-processes the determined task. In this way, the effect of predicting the affected task may be achieved.

When an exception occurs, i.e. when the terminal device is in the OFF state and the time to execute the scheduled task is reached, the terminal device is powered on automatically. After the task is executed, the terminal device is powered off automatically.

After an exception is likely to occur, i.e. the terminal device transits to the ON state from the OFF state or the terminal device adjusts the system time, a detection is made as to whether there is any task that should be executed but has not executed yet, and the detected task is processed. In this way, the effect of remedy is achieved.

According to the embodiments of the invention, the task may be monitored even in exceptional condition, and is performed according to the user's selection or performed automatically.

It will be apparent to persons skilled in the art that various changes and modifications are possible without departing from the spirit and scope of the invention. Therefore, the invention is intended to cover all modifications and changes falling within the claims and the equivalents of the invention.

What is claimed is:

1. A method for task processing in device management, comprising:
determining a scheduled task when the execution of the scheduled task is affected by a state of a terminal device or an operation of the terminal device; and
prompting a user to select a processing manner for the scheduled task, and processing the affected scheduled task according to the user's selection; or processing the scheduled task in a predetermined processing manner.

2. The method according to claim 1, wherein the predetermined processing manner comprises a preset processing policy or a system-default processing policy.

3. The method according to claim 2, wherein the preset processing policy comprises at least one of: a processing policy sent from a device management server and a processing policy preset by the user.

4. The method according to claim 1, wherein a state in which the terminal device is likely to affect the execution of the scheduled task is an OFF state; or
the execution of the scheduled task is likely to be affected when the terminal device attempts to perform an operation of: transiting to the OFF state from an ON state, or being powered on, or adjusting the system time.

5. The method according to claim 4, wherein when the terminal device is in the OFF state and the time to execute the scheduled task is reached, the terminal device is powered on automatically, and then powered off automatically after the scheduled task is completed.

6. The method according to claim 5, wherein before the terminal device is powered on automatically, a determination is made as to whether the terminal device is currently allowed to be powered on according to the user's setting.

7. The method according to claim 6, wherein before the scheduled task is executed, the terminal device determines whether the execution of the scheduled task is allowed under the conditions of the terminal device.

8. The method according to claim 4, wherein when the terminal device performs an operation of transiting to the OFF state from the ON state, the terminal device takes the current time as the starting time and determines a scheduled task to be affected within a preset time period.

9. The method according to claim 4, wherein after performing a power-on operation, the terminal device determines a scheduled task which has not been executed but should be executed within a time period when the OFF state lasts.

10. The method according to claim 4, wherein after performing an operation to adjust the system time, the terminal device determines a scheduled task which has not been executed but should be executed within a skipped time period caused by the time adjustment.

11. The method according to claim 1, wherein the scheduled task processing manner that may be selected by the user comprises: immediate execution, delayed execution and discard of execution.

12. The method according to claim 11, wherein the scheduled task processing manners are provided to the user according to the type of the task, for the user to make a selection.

13. A terminal device management system (500, 600), comprising:
a device management server (502, 602), configured to send a scheduled task and receive execution result;
a terminal device (504, 604), configured to interact with the device management server (502, 602); and
the terminal device (504, 604) further comprising a device management task exception processing module (5046, 6046), configured to determine a scheduled task when the execution of the scheduled task is affected by a state of the terminal device (504, 604) or an operation of the terminal device (504, 604), and prompt a user to select a processing manner for the scheduled task and process the affected scheduled task according to the user's selection, or process the scheduled task in a predetermined processing manner.

14. The system according to claim 13, wherein the device management server (502, 602) comprises a device management task framework module (5022, 6022), configured to send a scheduled task to the terminal device (504, 604), send the predetermined processing manner to the terminal device (504, 604), and process an interaction result and an execution result returned from the terminal device (504, 604).

15. A terminal device (504, 604), comprising:
a device management task processing module (5042, 6042), configured to process a scheduled task sent from a device management server (502, 602) and return an execution result;
a device management client module (5044, 6044) interacting directly with the device management server (502, 602), configured to forward signaling exchanged between the device management server (502, 602) and the terminal device (504, 604); and
a device management task exception processing module (5046, 6046), configured to determine a scheduled task when the execution of the scheduled task is affected by a state of the terminal device (504, 604) or an operation of the terminal device (504, 604), and prompt a user to select a processing manner for the scheduled task and process the affected scheduled task according to the user's selection, or process the scheduled task in a predetermined processing manner.

16. The terminal device according to claim 15, wherein the device management task exception processing module (5046, 6046) is configured to return a processing result through the device management task processing module (5042, 6042) and the device management client module (5044, 6044); or the device management task exception processing module (5046, 6046) is configured to return the processing result directly through the device management client module (5044, 6044).

17. The terminal device according to claim 15, wherein the device management task exception processing module (5046, 6046) is configured to receive and save the predetermined processing manner sent from the device management server (502, 602).
